(19) United States
(12) Patent Application Publication
(10) Pub. No.: US 2026/0129731 A1
(43) Pub. Date: May 7, 2026

(54) LEAKAGE PROTECTION CIRCUIT

(71) Applicant: Foshan Electrical and Lighting Co., Ltd., Foshan (CN)

(72) Inventors: Zongtai Huang, Foshan (CN); Shijun Fan, Foshan (CN); Junjie Zhao, Foshan (CN); Jiaxiong Qiu, Foshan (CN); Huifeng Feng, Foshan (CN)

(21) Appl. No.: 19/373,823

(22) Filed: Oct. 30, 2025

(30) Foreign Application Priority Data
Nov. 1, 2024 (CN) 202422674394.0
Dec. 31, 2024 (CN) 202411990854.9
Dec. 31, 2024 (CN) 202423319314.6

(51) Int. Cl. H05B 45/54; H05B 45/345; H05B 45/36; H05B 45/375

(52) U.S. Cl. CPC H05B 45/54; H05B 45/345; H05B 45/36; H05B 45/375

(57) ABSTRACT

The present disclosure provides a leakage protection circuit, relating to the field of light-emitting diode (LED) technologies and including a power supply circuit, a step-down circuit, an LED circuit, and a detection circuit. The power supply circuit includes an input terminal connected to output pins of a power supply terminal and an output terminal connected to an input terminal of the step-down circuit and an input terminal of the LED circuit. The step-down circuit includes an output terminal connected to the detection circuit. The detection circuit is connected to the output pins of the power supply terminal and the LED circuit, and is configured to control a working status of the LED circuit based on a real-time voltage difference between the output pins of the power supply terminal and the reference voltage output by the step-down circuit.

### CROSS REFERENCE TO RELATED APPLICATIONS

The present application claims the benefit of Chinese Patent Application Nos. 202422674394.0 filed on Nov. 1, 2024, 202411990854.9 filed on Dec. 31, 2024 and 202423319314.6 filed on Dec. 31, 2024. All the above are hereby incorporated by reference in their entirety.

### TECHNICAL FIELD

The present disclosure relates to the field of light-emitting diode (LED) technologies, and in particular, to a leakage protection circuit.

### BACKGROUND

At present, a lamp tube may be powered either by direct mains input or by connecting to a ballast. For the mains input, a voltage is typically 220V/50 Hz or the like. If the ballast is connected, connectors at two ends of the lamp tube have a high voltage.

In the lighting field, lamp tubes are classified into two types: single-ended input and double-ended input. Single-ended input has connectors of alternating current (AC) input terminals disposed at a same end, whereas double-ended input features connectors at two ends of the lamp tube. Because many lamp sockets still retain double-ended connection interfaces, double-ended input lamp tubes are usually installed during replacement of existing lamp tubes.

When installing a lamp tube, an operator usually inserts one end of the lamp tube into a lamp socket first, followed by the other end. At this time, partial conduction may occur. Because the operator's hand needs to grip the end of the lamp tube, accidental contact with conductive metal at the end can easily result in electric shock, compromising operational safety. Therefore, it is particularly important to implement leakage protection for the lamp tube.

In the prior art, leakage protection is primarily implemented by connecting a switch transistor to a power input terminal to detect a current flowing through the switch transistor and determine whether leakage occurs. However, the prior art is not effective at all times. When the input terminal is in poor contact, leakage protection circuit of the lamp tube fails, and the operator remains at risk of electric shock.

### SUMMARY

To resolve the foregoing technical problem, the present disclosure provides a leakage protection circuit, which can implement leakage protection.

To resolve the foregoing technical problem, the present disclosure provides a leakage protection circuit, including a power supply circuit, a step-down circuit, a light-emitting diode (LED) circuit, and a detection circuit; where the power supply circuit includes an input terminal connected to output pins of a power supply terminal and an output terminal connected to an input terminal of the step-down circuit and an input terminal of the LED circuit, and is configured to rectify output power from the power supply terminal to output supply power to the step-down circuit and the LED circuit; the step-down circuit includes an output terminal connected to the detection circuit, and is configured to step down the supply power output by the power supply circuit, to output a reference voltage to the detection circuit; and the detection circuit is connected to the output pins of the power supply terminal and the LED circuit, and is configured to control a working status of the LED circuit based on a real-time voltage difference between the output pins of the power supply terminal and the reference voltage output by the step-down circuit.

As an improvement of the above solution, the detection circuit includes two voltage difference detection modules, a control module, and a switch module, the control module is provided with two real-time sampling terminals and one reference sampling terminal, and the voltage difference detection modules, the real-time sampling terminals, and two groups of output pins of the power supply terminal are in a one-to-one correspondence; the voltage difference detection module is connected to the corresponding group of output pins to detect a real-time voltage difference between the corresponding group of output pins and control, based on the real-time voltage difference, a detection signal output by the voltage difference detection module; the real-time sampling terminal is connected to the corresponding voltage difference detection module to obtain the detection signal; the reference sampling terminal is connected to the output terminal of the step-down circuit to obtain the reference voltage; and the control module includes an output terminal connected to the switch module, and is configured to control an on-off state of the switch module based on the detection signal and the reference voltage.

As an improvement of the above solution, the voltage difference detection module includes a rectifier bridge and an optocoupler; the rectifier bridge is connected to the corresponding group of output pins to rectify output power between the output pins; and the optocoupler includes an input terminal connected to the rectifier bridge and an output terminal connected to the control module, and is configured to control an on-off state of the optocoupler based on a real-time voltage difference of rectified output power from the rectifier bridge.

As an improvement of the above solution, the switch module includes a first switch, and the first switch includes a control electrode connected to the output terminal of the control module, one electrode connected to the LED circuit, and the other electrode connected to the power supply circuit.

As an improvement of the above solution, the control module includes a second switch and a third switch; the second switch is connected to one of the real-time sampling terminals of the control module and the reference sampling terminal of the control module, and is configured to adjust an on-off state of the second switch based on the detection signal obtained by the one of the real-time sampling terminals and the reference voltage obtained by the reference sampling terminal; the third switch is connected to the other real-time sampling terminal of the control module and an output terminal of the second switch, and is configured to adjust an on-off state of the third switch based on the detection signal obtained by the other real-time sampling terminal and an output signal of the second switch; and an output terminal of the third switch is connected to the switch module, the on-off state of the third switch controls the on-off state of the switch module, and the on-off state of the switch module controls the working status of the LED circuit.

As an improvement of the above solution, when the second switch and the third switch are turned on, the switch module is turned on such that the power supply circuit, the LED circuit, and the detection circuit form an LED loop and the LED circuit works; and when the second switch and/or the third switch are/is turned off, the switch module is turned off to disconnect the LED circuit from the detection circuit.

As an improvement of the above solution, the second switch includes a control electrode connected to an output terminal of one of the voltage difference detection modules through one of the real-time sampling terminals, a first electrode connected to the output terminal of the step-down circuit through the reference sampling terminal, and a second electrode connected to a first electrode of the third switch; and the third switch includes a control electrode connected to an output terminal of the other voltage difference detection module through the other real-time sampling terminal and a second electrode connected to the switch module.

As an improvement of the above solution, the detection circuit further includes an anti-interference module, and the control module is connected to the switch module through the anti-interference module.

As an improvement of the above solution, the LED circuit includes a drive module and an LED module, and the drive module includes an input terminal connected to an output terminal of the LED module, and is configured to control a working status of the LED module based on the supply power; when the power supply circuit is connected to a ballast, the drive circuit does not work; and when the power supply circuit is connected to a mains supply, the drive circuit controls, based on the supply power, the drive module to be connected to or disconnected from the LED module, to control the working status of the LED circuit.

As an improvement of the above solution, the drive module includes a drive chip, the drive chip is provided with a detection pin and an open-drain pin, and a built-in switch is disposed in the open-drain pin; the detection pin is connected to the power supply circuit and configured to detect the supply power output by the power supply circuit; and the open-drain pin is connected to the LED module, and the built-in switch is turned on or off based on the supply power to control the drive module to be connected to or disconnected from the LED module.

The present disclosure has the following beneficial effects:

The leakage protection circuit in the present disclosure combines a real-time voltage difference between output pins of a power supply terminal with a reference voltage and uses an electrical signal between the output pins before rectification as a detection target and the voltage difference as a determining basis, to implement accurate leakage detection from a perspective of the voltage difference and greatly improve detection accuracy, thereby effectively controlling an on-off state of an LED circuit, preventing leakage, and ensuring personal safety.

Further, the leakage protection circuit in the present disclosure has control elements such as a switch transistor and an optocoupler introduced for flexible circuit switching, to control the on-off state of the LED circuit more accurately, achieving high accuracy.

### BRIEF DESCRIPTION OF THE DRAWINGS

FIG. 1 is a schematic structural diagram of a leakage protection circuit according to the present disclosure;

FIG. 2 is a circuit diagram of an embodiment of a leakage protection circuit according to the present disclosure;

FIG. 3 is a circuit diagram of an embodiment of a step-down circuit in a leakage protection circuit according to the present disclosure;

FIG. 4 is a circuit diagram of another embodiment of a step-down circuit in a leakage protection circuit according to the present disclosure; and

FIG. 5 is a circuit diagram of an embodiment of a drive module in a leakage protection circuit according to the present disclosure.

### DETAILED DESCRIPTION

To make the objectives, technical solutions, and advantages of the present disclosure clearer, the present disclosure will be further described in detail below with reference to the accompanying drawings. It should be noted that orientation terms such as “upper”, “lower”, “left”, “right”, “front”, “rear”, “inner”, and “outer” that appear or are about to appear in the present disclosure are only based on the accompanying drawings of the present disclosure, and do not specifically limit the present disclosure.

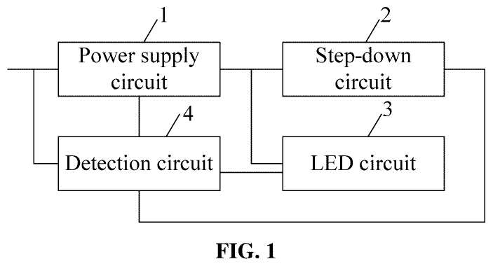

FIG. 1 shows a specific structure of a leakage protection circuit according to the present disclosure, including a power supply circuit 1, a step-down circuit 2, an LED circuit 3, and a detection circuit 4, which is specifically as follows:

The power supply circuit 1 includes an input terminal connected to output pins of a power supply terminal and an output terminal connected to an input terminal of the step-down circuit 2 and an input terminal of the LED circuit 3, and is configured to rectify output power from the power supply terminal to output supply power to the step-down circuit 2 and the LED circuit 3.

The step-down circuit 2 includes an output terminal connected to the detection circuit 4, and is configured to step down the supply power output by the power supply circuit 1, to output a reference voltage to the detection circuit 4.

The detection circuit 4 is connected to the output pins of the power supply terminal and the LED circuit 3, and is configured to control a working status of the LED circuit 3 based on a real-time voltage difference between the output pins of the power supply terminal and the reference voltage output by the step-down circuit 2, to implement leakage control.

It should be noted that the leakage protection circuit in the present disclosure may be applied to only a mains supply, or to both a mains supply and a ballast such that the power supply terminal may be a power supply terminal of the mains supply or a power supply terminal of the ballast. In addition, the leakage protection circuit in the present disclosure may separately implement leakage protection of the ballast or may implement leakage protection of both the ballast and the mains supply.

In the prior art, a leakage protection circuit usually detects a single electrical signal after rectification, to implement leakage protection. Different from the prior art, the leakage protection circuit in the present disclosure uses an electrical signal before rectification (namely, an electrical signal between the output pins) as a detection target and the voltage difference as a determining basis, to implement accurate leakage detection from a perspective of the voltage difference and greatly improve detection accuracy.

The following describes in detail the power supply circuit 1, the step-down circuit 2, the LED circuit 3, and the detection circuit 4 with reference to specific embodiments:
1. Power Supply Circuit 1

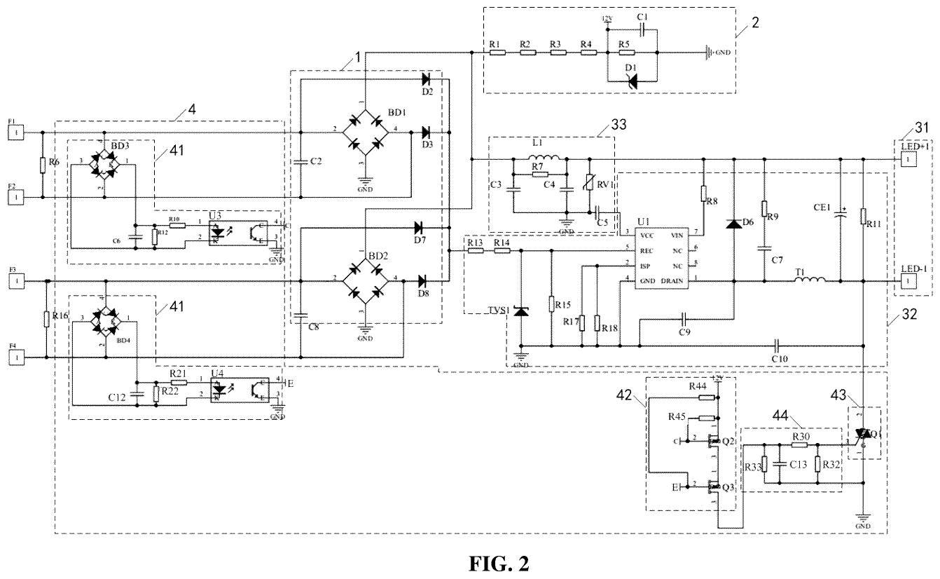

As shown in FIG. 2, in this embodiment, the power supply circuit 1 includes a first rectifier bridge BD1, a second rectifier bridge BD2, a second diode D2, a third diode D3, a seventh diode D7, an eighth diode D8, a second capacitor C2, an eighth capacitor C8, and input ports F1, F2, F3, and F4.

The first rectifier bridge BD1 includes one AC input terminal connected to the input port F1, the other AC input terminal connected to the input port F2, a negative direct current (DC) output terminal connected to the step-down circuit 2 and the LED circuit 3, and a positive DC output terminal that is grounded. The second diode D2 includes an anode connected to the input port F1 and a cathode connected to the LED circuit 3. The third diode D3 includes an anode connected to the input port F2 and a cathode connected to the LED circuit 3. The second capacitor C2 includes one terminal connected to the input port F1 and the other terminal connected to the input port F2.

Similarly, the second rectifier bridge BD2 includes one AC input terminal connected to the input port F3, the other AC input terminal connected to the input port F4, a negative DC output terminal connected to the step-down circuit 2 and the LED circuit 3, and a positive DC output terminal that is grounded. The seventh diode D7 includes an anode connected to the input port F3 and a cathode connected to the LED circuit 3. The eighth diode D8 includes an anode connected to the input port F4 and a cathode connected to the LED circuit 3. The eighth capacitor C8 includes one terminal connected to the input port F3 and the other terminal connected to the input port F4.

When the present disclosure is applied to a ballast, the input ports F1, F2, F3, and F4 may be connected to four pins of the ballast.

When the present disclosure is applied to a mains supply, any two input ports may be selected to be connected to two pins of the mains supply, for example, the input ports F1 and F2, the input ports F3 and F4, the input ports F1 and F3, the input ports F1 and F4, the input ports F2 and F3, or the input ports F2 and F4.

Therefore, the power supply circuit 1 can rectify the output power from the power supply terminal to output stable supply power to the step-down circuit 2 and the LED circuit 3.
2. Step-Down Circuit 2

As shown in FIG. 2, in this embodiment, the step-down circuit 2 includes a voltage divider resistor group (a first resistor R1, a second resistor R2, a third resistor R3, a fourth resistor R4, and a fifth resistor R5), a first capacitor C1, and a first Zener diode D1. The first resistor R1 includes one terminal connected to the power supply circuit 1 and the other terminal that is grounded through the second resistor R2, the third resistor R3, the fourth resistor R4, and the fifth resistor R5 in sequence. The fifth resistor R5 is connected in parallel to the first capacitor C1 and the first Zener diode D1. The first Zener diode D1 includes an anode that is grounded and a cathode connected to the detection circuit 4.

Therefore, the step-down circuit 2 can step down the supply power output by the power supply circuit 1 and convert it into a reference voltage of 12V for use by the detection circuit 4.

In another embodiment, a different quantity of resistors with a different resistance may be selected based on an actual requirement to perform step-down.

As shown in FIG. 3, in this embodiment, the voltage divider resistor group includes four resistors (the second resistor R2, the third resistor R3, the fourth resistor R4, and the fifth resistor R5) connected in series.

In another embodiment, step-down may be performed through a step-down chip.

As shown in FIG. 4, in this embodiment, the step-down circuit 2 includes a step-down chip U2, an eleventh diode D11, a twelfth diode D12, a third inductor L3, a fourth inductor L4, a sixteenth capacitor C16, a seventeenth capacitor C17, a second polarized capacitor CE2, a third polarized capacitor CE3, a fourth polarized capacitor CE4, a fortieth resistor R40, a forty-first resistor R41, and a current limiting resistor RS1. The step-down chip U2 includes a ground pin GND connected to a cathode of the twelfth diode D12, a clock pin SCL and a power supply pin VCC that are connected to a cathode of the eleventh diode D11, an open-drain pin DRAIN connected to the power supply circuit 1 through the third inductor L3, and a chip select pin CS connected to the cathode of the twelfth diode D12 through the current limiting resistor RS1. The twelfth diode D12 includes an anode that is grounded and the cathode connected to the detection circuit 4 through the fourth inductor L4 and to the cathode of the eleventh diode D11 through the seventeenth capacitor C17. An anode of the eleventh diode D11 is connected to the detection circuit 4. The fortieth resistor R40 includes one terminal connected to the detection circuit 4 and the other terminal that is grounded. The fortieth resistor R40, the sixteenth capacitor C16, and the second polarized capacitor CE2 are connected in parallel. The forty-first resistor R41 and the third inductor L3 are connected in parallel. The fourth polarized capacitor CE4 includes an anode connected to the open-drain pin DRAIN and a cathode that is grounded. The third polarized capacitor CE3 includes an anode connected to the power supply circuit 1 and a cathode that is grounded.

It should be noted that during a connection to a mains supply, whether a single-ended connection to the input ports F1 and F2, a single-ended connection to the input ports F3 and F4, or double-ended input, a rectified voltage from the first rectifier bridge BD1 and the second rectifier bridge BD2 is 310 VDC, which conforms to a working status of the step-down chip U2. Therefore, the step-down chip U2 can normally work to perform constant-current step-down and supply a constant reference voltage to the detection circuit 4.

Therefore, different step-down circuits 2 can be used to step down the power output by the power supply circuit 1 based on an actual requirement during application. This is not limited herein.
3. LED Circuit 3
(1) When the leakage protection circuit in the present disclosure is applied to only a ballast, the LED circuit 3 may not be provided with a drive module.
(2) When the leakage protection circuit in the present disclosure is applied to both a mains supply and a ballast, the LED circuit 3 includes a drive module 32 and an LED module 31, and an input terminal of the drive module 32 is connected to an output terminal of the LED module 31, which is specifically as follows:
(2.1) When the power supply circuit 1 is connected to the ballast, the drive module 32 does not work.
(2.2) When the power supply circuit 1 is connected to the mains supply and the drive module 32 has a leakage protection function, the drive module 32 controls, based on the supply power output by the power supply circuit 1, the drive module 32 to be connected to or disconnected from the LED module 31, to control the working status of the LED circuit 3.

For example, when the drive module 32 detects no leakage, the drive module 32 is connected to the LED module 31, and the drive module 32 drives the LED module 31, to ensure constant-current power supply to the LED module 31.

For another example, when the drive module 32 detects leakage, the drive module 32 is disconnected from the LED module 31, and the LED module 31 is open-circuited.

In some embodiments, the LED module 31 includes a plurality of LEDs connected in series. The drive module 32 includes a drive chip U1. The drive chip U1 is provided with a detection pin REC and an open-drain pin DRAIN. A built-in switch is disposed in the open-drain pin DRAIN. The detection pin REC is connected to the power supply circuit 1 and configured to detect the supply power output by the power supply circuit 1. The open-drain pin DRAIN is connected to the LED module 31. The built-in switch is turned on or off based on the supply power to control the drive module 32 to be connected to or disconnected from the LED module 31.

As shown in FIG. 2, in this embodiment, the drive module 32 includes the drive chip U1, a first transformer coil T1, a sixth diode D6, a Zener diode TVS1, a first polarized capacitor CE1, a seventh capacitor C7, a ninth capacitor C9, a tenth capacitor C10, an eighth resistor R8, a ninth resistor R9, an eleventh resistor R11, a thirteenth resistor R13, a fourteenth resistor R14, a fifteenth resistor R15, a seventeenth resistor R17, and an eighteenth resistor R18. The drive chip U1 includes the open-drain pin DRAIN connected to a cathode of the LED module 31 through the first transformer coil T1, a compile pin that is grounded through the seventeenth resistor R17 and the eighteenth resistor R18, a ground pin GND that is grounded and connected to an anode of the sixth diode D6 through the ninth capacitor C9, the detection pin REC connected to the power supply circuit 1 through the fourteenth resistor R14 and the thirteenth resistor R13 in sequence and grounded through the Zener diode TVS1 and the fifteenth resistor R15, and a power supply pin VIN connected to the anode of the LED module through the eighth resistor R8. A cathode of the sixth diode D6 is connected to an anode of the LED module 31. The tenth capacitor C10 includes one terminal that is grounded and the other terminal connected to the detection circuit 4 and the cathode of the LED module 31. The ninth resistor R9 includes one terminal connected to the anode of the LED module 31 and the other terminal connected to the open-drain pin DRAIN through the seventh capacitor C7. The first polarized capacitor CE1 includes one terminal connected to the anode of the LED module 31 and the other terminal connected to the cathode of the LED module 31. The eleventh resistor R11 and the first polarized capacitor CE1 are connected in parallel.

It should be noted that the detection pin REC of the drive chip U1 has an input current detection function. When the current of the supply power is greater than 72 mA, the drive chip U1 turns on the built-in switch in the open-drain pin DRAIN. When the current of the supply power is less than 72 mA, the drive chip U1 turns off the built-in switch in the open-drain pin DRAIN. Preferably, the drive chip U1 may be JW1830, JW1831, JW1832, or another solution of a same category, but is not limited thereto.

Further, in this embodiment, the LED circuit 3 further includes a filter circuit 33. The filter circuit 33 includes an input terminal connected to an output terminal of the power supply circuit 1 and an output terminal connected to the drive module 32 and the LED module 31.

As shown in FIG. 2, in this embodiment, the filter circuit 33 includes a first inductor L1, a third capacitor C3, a fourth capacitor C4, a fifth capacitor C5, a seventh resistor R7, and a thermistor RV1. A power supply pin VCC of the drive chip U1 is grounded through the fifth capacitor C5. The thermistor RV1 includes one terminal connected to the anode of the LED module 31 and the other terminal that is grounded. The third capacitor C3 includes one terminal connected to the power supply circuit 1 and the other terminal that is grounded. The fourth capacitor C4 includes one terminal connected to the anode of the LED module and the other terminal that is grounded. The first inductor L1 includes one terminal connected to the power supply circuit 1 and the other terminal connected to the anode of the LED module. The seventh resistor R7 and the first inductor L1 are connected in parallel.

Therefore, the filter circuit 33 can filter a power supply voltage output by the power supply circuit 1, to supply power to the drive module 32 and the LED module 31.
(2.3) When the power supply circuit 1 is connected to the mains supply and the drive module 32 has no leakage protection function, the drive module 32 works to drive the LED module 31, to ensure constant-current power supply to the LED module 31.

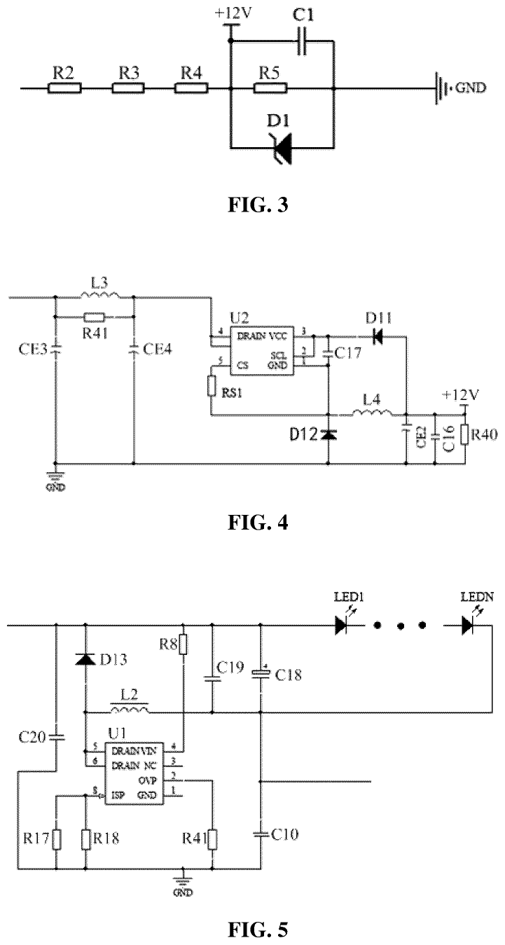

As shown in FIG. 5, in this embodiment, the drive module 32 includes a drive chip U1, a second inductor L2, a thirteenth diode D13, a tenth capacitor C10, an eighteenth polarized capacitor C18, a nineteenth capacitor C19, a twentieth capacitor C20, an eighth resistor R8, a seventeenth resistor R17, an eighteenth resistor R18, and a forty-first resistor R41. The drive chip U1 includes an overvoltage protection pin OVP that is grounded through the forty-first resistor R41, a power input pin VIN connected to an anode of the LED module 31 through the eighth resistor R8, an open-drain pin DRAIN connected to the anode of the LED module 31 through the thirteenth diode D13 and to a cathode of the LED module 31 through the second inductor L2, and a compile pin that is grounded through the seventeenth resistor R17 and the eighteenth resistor R18. The twentieth capacitor C20 includes one terminal connected to the anode of the LED module 31 and the other terminal that is grounded. The eighteenth polarized capacitor C18 includes an anode connected to the anode of the LED module 31 and a cathode connected to the detection circuit 4 and the cathode of the LED module 31 and grounded through the tenth capacitor C10. The eighteenth polarized capacitor C18 and the nineteenth capacitor C19 are connected in parallel.

Therefore, during the connection to the mains supply, the drive chip U1 can drive the LED module 31 at a constant current to ensure that the LED module 31 can be normally used.
4. Detection Circuit 4

As shown in FIG. 2, the detection circuit 4 includes two voltage difference detection modules 41, a control module 42, and a switch module 43. The control module 42 is provided with two real-time sampling terminals and one reference sampling terminal. The voltage difference detection modules 41, the real-time sampling terminals, and two groups of output pins of the power supply terminal are in a one-to-one correspondence.

The voltage difference detection module 41 is connected to the corresponding group of output pins to detect a real-time voltage difference between the corresponding group of output pins and control, based on the real-time voltage difference, a detection signal output by the voltage difference detection module 41.

The real-time sampling terminal is connected to the corresponding voltage difference detection module 41 to obtain the detection signal.

The reference sampling terminal is connected to the output terminal of the step-down circuit 2 to obtain the reference voltage.

The control module 42 includes an output terminal connected to the switch module 43, and is configured to control an on-off state of the switch module 43 based on the detection signal and the reference voltage.

Therefore, through cooperation among the voltage difference detection modules 41, the control module 42, and the switch module 43, the switch module 43 can perform accurate on-off switching based on the real-time voltage difference between the output pins and the reference voltage from the step-down circuit 2, achieving high accuracy.

The following describes in detail the voltage difference detection modules 41, the control module 42, and the switch module 43:
(1) Voltage Difference Detection Modules

The voltage difference detection module 41 includes a rectifier bridge and an optocoupler. The rectifier bridge is connected to the corresponding group of output pins to rectify output power between the output pins. The optocoupler includes an input terminal connected to the rectifier bridge and an output terminal connected to the control module 42, and is configured to control an on-off state of the optocoupler based on a real-time voltage difference of rectified output power from the rectifier bridge.

As shown in FIG. 2, in this embodiment, the voltage difference detection modules 41 include a third rectifier bridge BD3, a fourth rectifier bridge BD4, a tenth resistor R10, a twelfth resistor R12, a twenty-first resistor R21, a twenty-second resistor R22, a sixth capacitor C6, a twelfth capacitor C12, a first optocoupler U3, and a second optocoupler U4, which is specifically as follows:

The third rectifier bridge BD3 includes one AC input terminal connected to the input port F1 and the other AC input terminal connected to the input port F2. The sixth capacitor C6 includes one terminal connected to a negative DC output terminal of the third rectifier bridge BD3 and the other terminal connected to a positive DC output terminal of the third rectifier bridge BD3. The twelfth resistor R12 and the sixth capacitor C6 are connected in parallel. The first optocoupler U3 includes an emitting diode whose anode is connected to the negative DC output terminal of the third rectifier bridge BD3 through the tenth resistor R10 and whose cathode is connected to the positive DC output terminal of the third rectifier bridge BD3, a collector connected to one of the real-time sampling terminals of the control module 42, and an emitter that is grounded.

Similarly, the fourth rectifier bridge BD4 includes one AC input terminal connected to the input port F3 and the other AC input terminal connected to the input port F4. The twelfth capacitor C12 includes one terminal connected to a negative DC output terminal of the fourth rectifier bridge BD4 and the other terminal connected to a positive DC output terminal of the fourth rectifier bridge BD4. The twenty-second resistor R22 and the twelfth capacitor C12 are connected in parallel. The second optocoupler U4 includes an emitting diode whose anode is connected to the negative DC output terminal of the fourth rectifier bridge BD4 through the twenty-first resistor R21 and whose cathode is connected to the positive DC output terminal of the fourth rectifier bridge BD4, a collector connected to the other real-time sampling terminal, and an emitter that is grounded.

Therefore, the voltage difference detection modules 41 can effectively detect the real-time voltage difference between the output pins through cooperation among various components, to flexibly control the on-off state of the optocoupler, thereby outputting different detection signals to the control module 42.
(2) Control Module

In some embodiments, the control module 42 includes a second switch Q2 and a third switch Q3. The second switch Q2 is connected to one of the real-time sampling terminals of the control module 42 and the reference sampling terminal of the control module 42, and is configured to adjust an on-off state of the second switch Q2 based on the detection signal obtained by the one of the real-time sampling terminals and the reference voltage obtained by the reference sampling terminal. The third switch Q3 is connected to the other real-time sampling terminal of the control module 42 and an output terminal of the second switch Q2, and is configured to adjust an on-off state of the third switch Q3 based on the detection signal obtained by the other real-time sampling terminal and an output signal of the second switch Q2. An output terminal of the third switch Q3 is connected to the switch module 43. The on-off state of the third switch Q3 controls the on-off state of the switch module 43. The on-off state of the switch module 43 controls the working status of the LED circuit 3.

Further, the second switch Q2 includes a control electrode connected to an output terminal of one of the voltage difference detection modules 41 through one of the real-time sampling terminals, a first electrode connected to the output terminal of the step-down circuit 2 through the reference sampling terminal, and a second electrode connected to a first electrode of the third switch Q3. The third switch Q3 includes a control electrode connected to an output terminal of the other voltage difference detection module 41 through the other real-time sampling terminal and a second electrode connected to the switch module 43.

As shown in FIG. 2, in this embodiment, the control module 42 includes the second switch Q2, the third switch Q3, a forty-fourth resistor R44, and a forty-fifth resistor R45. The second switch Q2 includes a source connected to the step-down circuit 2, a gate connected to one of the voltage difference detection modules 41, and a drain connected to a source of the third switch Q3. The third switch Q3 includes a gate connected to the other voltage difference detection module 41 and a drain connected to the switch module 43. The forty-fourth resistor R44 includes one terminal connected to the step-down circuit 2 and the other terminal connected to the gate of the third switch Q3. The forty-fifth resistor R45 includes one terminal connected to the step-down circuit 2 and the other terminal connected to the gate of the second switch Q2.

Therefore, when the second switch Q2 and the third switch Q3 are turned on, the switch module 43 is turned on such that the power supply circuit 1, the LED circuit 3, and the detection circuit 4 form an LED loop and the LED circuit 3 works; and when the second switch Q2 and/or the third switch Q3 are/is turned off, the switch module 43 is turned off to disconnect the LED circuit 1 from the detection circuit 4.
(3) Switch Module

As shown in FIG. 2, in this embodiment, the switch module 43 includes a first switch Q1. The first switch Q1 includes a control electrode connected to the output terminal of the control module 42, one electrode connected to the LED circuit 3, and the other electrode connected to the power supply circuit 1.

Therefore, when the first switch Q1 is turned on, the power supply circuit 1, the LED circuit 3, and the detection circuit 4 form an LED loop and the LED circuit 3 works; and when the first switch Q1 is turned off, the LED circuit 3 is disconnected from the detection circuit 4.

Further, the detection circuit 4 further includes an anti-interference module 44. The control module 42 is connected to the switch module 43 through the anti-interference module 44.

As shown in FIG. 2, in this embodiment, the anti-interference module 44 includes a thirtieth resistor R30, a thirty-second resistor R32, and an RC circuit (a thirty-third resistor R33 and a thirteenth capacitor C13 connected in parallel). The thirtieth resistor R30 is connected in series between the control module 42 and the switch module 43. The thirty-second resistor R32 includes one terminal connected to the switch module 43 and the other terminal connected to the power supply circuit (that is, grounded). The RC circuit includes one terminal connected to the control module 42 and the other terminal connected to the power supply circuit (that is, grounded).

Therefore, the anti-interference module 44 can isolate the control module 42 from the switch module 43 to avoid interference with the switch module 43 and improve accuracy of the switch module 43.

The following further describes a leakage detection principle in the embodiment shown in FIG. 2:
1. Connection to a Ballast

During a connection to a ballast, there is a real-time voltage difference between the input ports F1 and F2. After the real-time voltage difference is rectified by the third rectifier bridge BD3, a current passes through the tenth resistor R10 to turn on the first optocoupler U3. At this time, a voltage at the collector C of the first optocoupler U3 is pulled to ground by a transistor to turn on the second switch Q2.

Similarly, there is a real-time voltage difference between the input ports F3 and F4. After the real-time voltage difference is rectified by the fourth rectifier bridge BD4, a current passes through the twenty-first resistor R21 to turn on the second optocoupler U4. At this time, a voltage at the collector E of the second optocoupler U4 is pulled to ground by a transistor to turn on the third switch Q3.

The voltage enters the control electrode of the first switch Q1 through the second switch Q2 and the third switch Q3. At this time, the first switch Q1 is turned on such that output power from the power supply circuit 1 flows from the negative DC output terminals of the first rectifier bridge BD1 and the second rectifier bridge BD2 to the first inductor L1, the LED module 31, and the first switch Q1 in sequence, and finally returns to the positive DC output terminals of the first rectifier bridge BD1 and the second rectifier bridge BD2 to form an LED loop. In this way, the LED module 31 lights up. At this point, the cathode of the LED module 31 is pulled to ground by the first switch Q1. In this case, the open-drain pin DRAIN of the drive chip U1 is equivalent to being grounded. The drive chip U1 does not meet a working condition and does not participate in work.

If one end of a lamp tube becomes detached, there is no voltage difference between the input ports F1 and F2 or F3 and F4. At this point, the second switch Q2 or the third switch Q3 is turned off. Because one of the switches is turned off, there is no voltage and current at the control electrode of the first switch Q1, and the first switch Q1 is turned off such that the LED loop is cut off. This enables installation personnel to safely touch the other end and prevents leakage.
2. Connection to a Mains Supply

During a connection to a mains supply, the power supply circuit 1 can normally work in either single-ended or double-ended mode. When mains power is input to the input ports F1 and F2 or F3 and F4, an input voltage is subject to an actual solution and may be wide-range, narrow-range, a specific voltage, or the like. The following uses 220V/50Hz to describe a working principle:

During the connection to the mains supply, the voltage is input through the input ports F1 and F2, the input ports F3 and F4, or a permutation and combination of the input ports F1 and F2 with the input ports F3 and F4 (for example, F1 and F3, F1 and F4, F2 and F3, or F2 and F4). However, regardless of the combination, two pins are used for input. At this point, the second switch Q2 or the third switch Q3 is turned off. Because one of the switches is turned off, there is no voltage and current at the control electrode of the first switch Q1, and the first switch Q1 is turned off such that the first switch Q1 does not work without affecting working of the drive chip U1. In this way, output power from the power supply circuit 1 flows from the negative DC output terminals of the first rectifier bridge BD1 and the second rectifier bridge BD2 to the first inductor L1, the LED module 31, the open-drain pin DRAIN, the drive chip U1, and the compile pin in sequence, and finally returns to the positive DC output terminals of the first rectifier bridge BD1 and the second rectifier bridge BD2 to form an LED loop. In this way, the LED module 31 normally lights up.

At this time, if a pin for input becomes detached and comes into contact with a person, this is equivalent to connecting the detection pin REC of the drive chip U1 to a resistor because an internal resistance of the person is greater than 500 Ω, and a current at the detection pin REC decreases from greater than 72 mA to less than 72 mA. At this point, the built-in switch in the open-drain pin DRAIN is turned off such that the LED loop is cut off for leakage protection.

In summary, the leakage protection circuit in the present disclosure combines the real-time voltage difference between the output pins of the power supply terminal with the reference voltage and uses an electrical signal between the output pins before rectification as a detection target and the voltage difference as a determining basis, to implement accurate leakage detection from a perspective of the voltage difference and greatly improve detection accuracy, thereby effectively controlling an on-off state of the LED circuit, preventing leakage, and ensuring personal safety. Further, the leakage protection circuit in the present disclosure has control elements such as a switch transistor and an optocoupler introduced for flexible circuit switching, to control the on-off state of the LED circuit more accurately, achieving high accuracy.

The foregoing descriptions are preferred implementations of the present disclosure. It should be noted that for a person of ordinary skill in the art, various improvements and modifications can be made without departing from the principle of the present disclosure. These improvements and modifications should also be regarded as falling within the protection scope of the present disclosure.

1. A leakage protection circuit, comprising a power supply circuit, a step-down circuit, a light-emitting diode (LED) circuit, and a detection circuit; wherein
the power supply circuit comprises an input terminal connected to output pins of a power supply terminal and an output terminal connected to an input terminal of the step-down circuit and an input terminal of the LED circuit, and is configured to rectify output power from the power supply terminal to output supply power to the step-down circuit and the LED circuit;
the step-down circuit comprises an output terminal connected to the detection circuit, and is configured to step down the supply power output by the power supply circuit, to output a reference voltage to the detection circuit; and
the detection circuit is connected to the output pins of the power supply terminal and the LED circuit, and is configured to control a working status of the LED circuit based on a real-time voltage difference between the output pins of the power supply terminal and the reference voltage output by the step-down circuit.

2. The leakage protection circuit according to claim 1, wherein the detection circuit comprises two voltage difference detection modules, a control module, and a switch module, the control module is provided with two real-time sampling terminals and one reference sampling terminal, and the voltage difference detection modules, the real-time sampling terminals, and two groups of output pins of the power supply terminal are in a one-to-one correspondence;
the voltage difference detection module is connected to the corresponding group of output pins to detect a real-time voltage difference between the corresponding group of output pins and control, based on the real-time voltage difference, a detection signal output by the voltage difference detection module;
the real-time sampling terminal is connected to the corresponding voltage difference detection module to obtain the detection signal;
the reference sampling terminal is connected to the output terminal of the step-down circuit to obtain the reference voltage; and
the control module comprises an output terminal connected to the switch module, and is configured to control an on-off state of the switch module based on the detection signal and the reference voltage.

3. The leakage protection circuit according to claim 2, wherein the voltage difference detection module comprises a rectifier bridge and an optocoupler;
the rectifier bridge is connected to the corresponding group of output pins to rectify output power between the output pins; and
the optocoupler comprises an input terminal connected to the rectifier bridge and an output terminal connected to the control module, and is configured to control an on-off state of the optocoupler based on a real-time voltage difference of rectified output power from the rectifier bridge.

4. The leakage protection circuit according to claim 2, wherein the switch module comprises a first switch, and the first switch comprises a control electrode connected to the output terminal of the control module, one electrode connected to the LED circuit, and the other electrode connected to the power supply circuit.

5. The leakage protection circuit according to claim 2, wherein the control module comprises a second switch and a third switch;
the second switch is connected to one of the real-time sampling terminals of the control module and the reference sampling terminal of the control module, and is configured to adjust an on-off state of the second switch based on the detection signal obtained by the one of the real-time sampling terminals and the reference voltage obtained by the reference sampling terminal;
the third switch is connected to the other real-time sampling terminal of the control module and an output terminal of the second switch, and is configured to adjust an on-off state of the third switch based on the detection signal obtained by the other real-time sampling terminal and an output signal of the second switch; and
an output terminal of the third switch is connected to the switch module, the on-off state of the third switch controls the on-off state of the switch module, and the on-off state of the switch module controls the working status of the LED circuit.

6. The leakage protection circuit according to claim 5, wherein
when the second switch and the third switch are turned on, the switch module is turned on such that the power supply circuit, the LED circuit, and the detection circuit form an LED loop and the LED circuit works; and
when the second switch and/or the third switch are/is turned off, the switch module is turned off to disconnect the LED circuit from the detection circuit.

7. The leakage protection circuit according to claim 5, wherein
the second switch comprises a control electrode connected to an output terminal of one of the voltage difference detection modules through one of the real-time sampling terminals, a first electrode connected to the output terminal of the step-down circuit through the reference sampling terminal, and a second electrode connected to a first electrode of the third switch; and
the third switch comprises a control electrode connected to an output terminal of the other voltage difference detection module through the other real-time sampling terminal and a second electrode connected to the switch module.

8. The leakage protection circuit according to claim 2, wherein the detection circuit further comprises an anti-interference module, and the control module is connected to the switch module through the anti-interference module.

9. The leakage protection circuit according to claim 1, wherein the LED circuit comprises a drive module and an LED module, and the drive module comprises an input terminal connected to an output terminal of the LED module, and is configured to control a working status of the LED module based on the supply power;
when the power supply circuit is connected to a ballast, the LED circuit does not work; and
when the power supply circuit is connected to a mains supply, the LED circuit controls, based on the supply power, the drive module to be connected to or disconnected from the LED module, to control the working status of the LED circuit.

10. The leakage protection circuit according to claim 9, wherein the drive module comprises a drive chip, the drive chip is provided with a detection pin and an open-drain pin, and a built-in switch is disposed in the open-drain pin;
the detection pin is connected to the power supply circuit and configured to detect the supply power output by the power supply circuit; and
the open-drain pin is connected to the LED module, and the built-in switch is turned on or off based on the supply power to control the drive module to be connected to or disconnected from the LED module.
